(19) United States
(12) Patent Application Publication
(10) Pub. No.: US 2026/0133775 A1
(43) Pub. Date: May 14, 2026

(54) APPARATUS, SYSTEM, AND METHOD OF COMPILING CODE FOR A PROCESSOR

(71) Applicant: MobilEye Vision Technologies Ltd., Jerusalem (IL)

(72) Inventors: Gil RAPAPORT, Moledet (IL); Dorit NUZMAN, Haifa (IL)

(73) Assignee: MobilEye Vision Technologies Ltd., Jerusalem (IL)

(21) Appl. No.: 19/119,430

(22) PCT Filed: Oct. 12, 2023
(86) PCT No.: PCT/IB2023/060304

§ 371 Date: Apr. 9, 2025

Related U.S. Application Data
(60) Provisional application No. 63/415,306, filed on Oct. 12, 2022.

(51) Int. Cl. G06F 8/41

(52) U.S. Cl. CPC G06F 8/41

(57) ABSTRACT

For example, a compiler may be configured to identify a select instruction in a loop operation based on a source code, the select instruction to select between a first value and a second value according to a mask in the select instruction: to configure a masked operation in the loop operation based on the select instruction, wherein the masked operation is based on the mask in the select instruction, the masked operation including a passthrough value based on the second value; and to generate target code based on compilation of the source code, wherein the target code is based on the masked operation.

### CROSS REFERENCE

This application claims the benefit of and priority from U.S. Provisional Patent Application No. 63/415,306 entitled “APPARATUS, SYSTEM, AND METHOD OF COMPILING CODE FOR A PROCESSOR”, filed Oct. 12, 2022, the entire disclosure of which is incorporated herein by reference.

### BACKGROUND

A compiler may be configured to compile source code into target code configured for execution by a processor.

There is a need to provide a technical solution to support efficient processing functionalities.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a compiler, in accordance with some demonstrative aspects.

FIG. 3 is a schematic illustration of a vector processor, in accordance with some demonstrative aspects.

FIG. 4 is a schematic flow-chart illustration of a method of compiling code for a processor, in accordance with some demonstrative aspects.

FIG. 5 is a schematic illustration of a product, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities capture the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”. “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects, for example, may capture the form of an entirely hardware aspect, an entirely software aspect, or an aspect including both hardware and software elements. Some aspects may be implemented in software, which includes but is not limited to firmware, resident software, microcode, or the like.

Furthermore, some aspects may capture the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some demonstrative aspects, the medium may be an electronic, magnetic, optical, electromagnetic, infrared, or semiconductor system (or apparatus or device) or a propagation medium.

In some demonstrative aspects, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative aspects, input/output or I/O devices (including but not limited to keyboards, displays, pointing devices, etc.) may be coupled to the system either directly or through intervening I/O controllers. In some demonstrative aspects, network adapters may be coupled to the system to enable the data processing system to become coupled to other data processing systems or remote printers or storage devices, for example, through intervening private or public networks. In some demonstrative aspects, modems, cable modems and Ethernet cards are demonstrative examples of types of network adapters. Other suitable components may be used.

Some aspects may be used in conjunction with various devices and systems, for example, a computing device, a computer, a mobile computer, a non-mobile computer, a server computer, or the like.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., processor circuitry, control circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

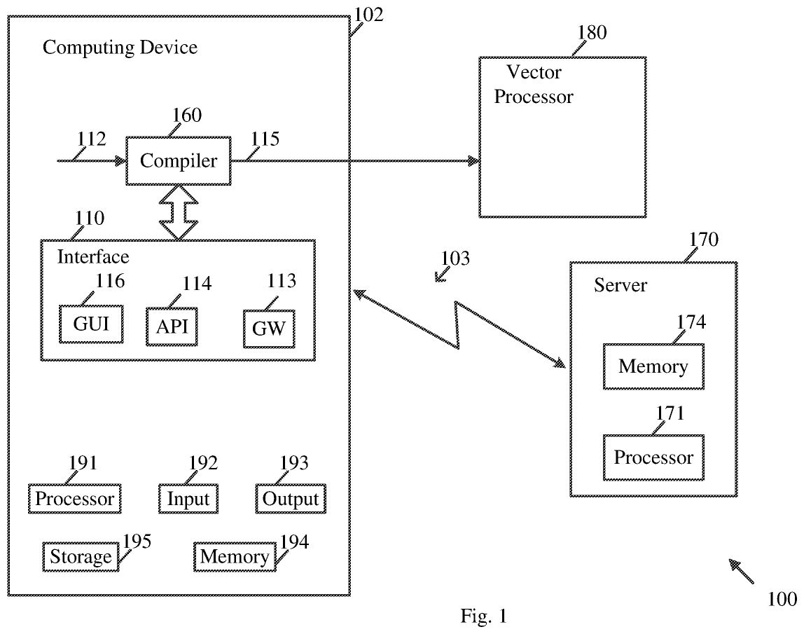

Reference is now made to FIG. 1, which schematically illustrates a block diagram of a system 100, in accordance with some demonstrative aspects.

As shown in FIG. 1, in some demonstrative aspects system 100 may include a computing device 102.

In some demonstrative aspects, device 102 may be implemented using suitable hardware components and/or software components, for example, processors, controllers, memory units, storage units, input units, output units, communication units, operating systems, applications, or the like.

In some demonstrative aspects, device 102 may include, for example, a computer, a mobile computing device, a non-mobile computing device, a laptop computer, a notebook computer, a tablet computer, a handheld computer, a Personal Computer (PC), or the like.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of one or more of device 102 may be enclosed in a common housing or packaging, and may be interconnected or operably associated using one or more wired or wireless links. In other aspects, components of one or more of device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 may include, for example, a hard disk drive, a Solid State Drive (SSD), or other suitable removable or non-removable storage units. Memory unit 194 and/or storage unit 195, for example, may store data processed by device 102.

In some demonstrative aspects, device 102 may be configured to communicate with one or more other devices via at least one network 103, e.g., a wireless and/or wired network.

In some demonstrative aspects, network 103 may include a wired network, a local area network (LAN), a wireless network, a wireless LAN (WLAN) network, a radio network, a cellular network, a WiFi network, an IR network, a Bluetooth (BT) network, and the like.

In some demonstrative aspects, device 102 may be configured to perform and/or to execute one or more operations, modules, processes, procedures and/or the like, e.g., as described herein.

In some demonstrative aspects, device 102 may include a compiler 160, which may be configured to generate a target code 115, for example, based on a source code 112, e.g., as described below.

In some demonstrative aspects, compiler 160 may be configured to translate the source code 112 into the target code 115, e.g., as described below.

In some demonstrative aspects, compiler 160 may include, or may be implemented as, software, a software module, an application, a program, a subroutine, instructions, an instruction set, computing code, words, values, symbols, and/or the like.

In some demonstrative aspects, the source code 112 may include computer code written in a source language.

In some demonstrative aspects, the source language may include a programing language. For example, the source language may include a high-level programming language, for example, such as, C language, C++ language, and/or the like.

In some demonstrative aspects, the target code 115 may include computer code written in a target language.

In some demonstrative aspects, the target language may include a low-level language, for example, such as, assembly language, object code, machine code, or the like.

In some demonstrative aspects, the target code 115 may include one or more object files, e.g., which may create and/or form an executable program.

In some demonstrative aspects, the executable program may be configured to be executed on a target computer. For example, the target computer may include a specific computer hardware, a specific machine, and/or a specific operating system.

In some demonstrative aspects, the executable program may be configured to be executed on a processor 180, e.g., as described below.

In some demonstrative aspects, processor 180 may include a vector processor 180, e.g., as described below. In other aspects, processor 180 may include any other type of processor.

Some demonstrative aspects are described herein with respect to a compiler, e.g., compiler 160, configured to compile source code 112 into target code 115 configured to be executed by a vector processor 180, e.g., as described below. In other aspects, a compiler, e.g., compiler 160, configured to compile source code 112 into target code 115 configured to be executed by any other type of processor 180.

In some demonstrative aspects, processor 180 may be implemented as part of device 102.

In other aspects, processor 180 may be implemented as part of any other device, e.g., separate from device 102.

In some demonstrative aspects, vector processor 180 (also referred to as an “array processor”) may include a processor, which may be configured to process an entire vector in one instruction, e.g., as described below.

In other aspects, the executable program may be configured to be executed on any other additional or alternative type of processor.

In some demonstrative aspects, the vector processor 180 may be designed to support high-performance image and/or vector processing. For example, the vector processor 180 may be configured to processes 1/2/3/4D arrays of fixed point data and/or floating point arrays, e.g., very quickly and/or efficiently.

In some demonstrative aspects, the vector processor 180 may be configured to process arbitrary data, e.g., structures with pointers to structures. For example, the vector processor 180 may include a scalar processor to compute the non-vector data, for example, assuming the non-vector data is minimal.

In some demonstrative aspects, compiler 160 may be implemented as a local application to be executed by device 102. For example, memory unit 194 and/or storage unit 195 may store instructions resulting in compiler 160, and/or processor 191 may be configured to execute the instructions resulting in compiler 160 and/or to perform one or more calculations and/or processes of compiler 160, e.g., as described below.

In other aspects, compiler 160 may include a remote application to be executed by any suitable computing system, e.g., a server 170.

In some demonstrative aspects, server 170 may include at least a remote server, a web-based server, a cloud server, and/or any other server.

In some demonstrative aspects, the server 170 may include a suitable memory and/or storage unit 174 having stored thereon instructions resulting in compiler 160, and a suitable processor 171 to execute the instructions, e.g., as descried below.

In some demonstrative aspects, compiler 160 may include a combination of a remote application and a local application.

In one example, compiler 160 may be downloaded and/or received by the user of device 102 from another computing system, e.g., server 170, such that compiler 160 may be executed locally by users of device 102. For example, the instructions may be received and stored, e.g., temporarily, in a memory or any suitable short-term memory or buffer of device 102, e.g., prior to being executed by processor 191 of device 102.

In another example, compiler 160 may include a client-module to be executed locally by device 102, and a server module to be executed by server 170. For example, the client-module may include and/or may be implemented as a local application, a web application, a web site, a web client, e.g., a Hypertext Markup Language (HTML) web application, or the like.

For example, one or more first operations of compiler 160 may be performed locally, for example, by device 102, and/or one or more second operations of compiler 160 may be performed remotely, for example, by server 170.

In other aspects, compiler 160 may include, or may be implemented by, any other suitable computing arrangement and/or scheme.

In some demonstrative aspects, system 100 may include an interface 110, e.g., a user interface, to interface between a user of device 102 and one or more elements of system 100, e.g., compiler 160.

In some demonstrative aspects, interface 110 may be implemented using any suitable hardware components and/or software components, for example, processors, controllers, memory units, storage units, input units, output units, communication units, operating systems, and/or applications.

In some aspects, interface 110 may be implemented as part of any suitable module, system, device, or component of system 100.

In other aspects, interface 110 may be implemented as a separate element of system 100.

In some demonstrative aspects, interface 110 may be implemented as part of device 102. For example, interface 110 may be associated with and/or included as part of device 102.

In one example, interface 110 may be implemented, for example, as middleware, and/or as part of any suitable application of device 102. For example, interface 110 may be implemented as part of compiler 160 and/or as part of an OS of device 102.

In some demonstrative aspects, interface 110 may be implemented as part of server 170. For example, interface 110 may be associated with and/or included as part of server 170.

In one example, interface 110 may include, or may be part of a Web-based application, a web-site, a web-page, a plug-in, an ActiveX control, a rich content component, e.g., a Flash or Shockwave component, or the like.

In some demonstrative aspects, interface 110 may be associated with and/or may include, for example, a gateway (GW) 113 and/or an Application Programming Interface (API) 114, for example, to communicate information and/or communications between elements of system 100 and/or to one or more other, e.g., internal or external, parties, users, applications and/or systems.

In some aspects, interface 110 may include any suitable Graphic-User-Interface (GUI) 116 and/or any other suitable interface.

In some demonstrative aspects, interface 110 may be configured to receive the source code 112, for example, from a user of device 102, e.g., via GUI 116, and/or API 114.

In some demonstrative aspects, interface 110 may be configured to transfer the source code 112, for example, to compiler 160, for example, to generate the target code 115, e.g., as described below.

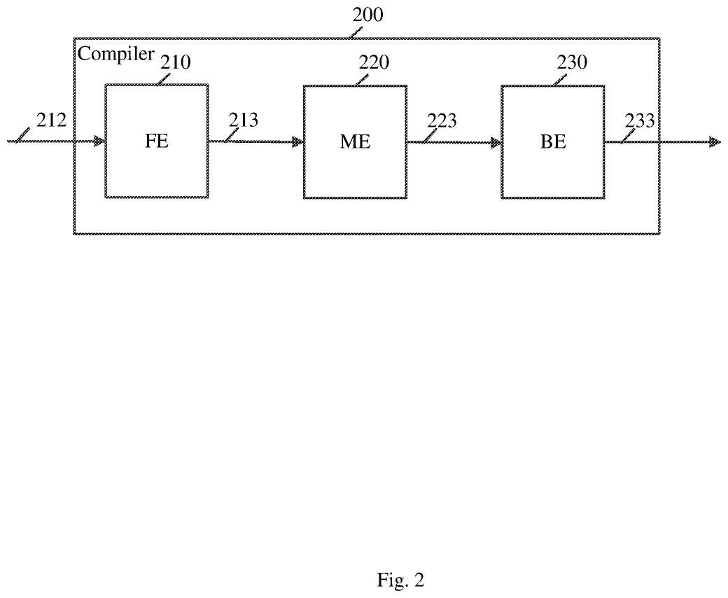

Reference is made to FIG. 2, which schematically illustrates a compiler 200, in accordance with some demonstrative aspects. For example, compiler 160 (FIG. 1) may be implement one or more elements of compiler 200, and/or may perform one or more operations and/or functionalities of compiler 200.

In some demonstrative aspects, as shown in FIG. 2, compiler 200 may be configured to generate a target code 233, for example, by compiling a source code 212 in a source language.

In some demonstrative aspects, as shown in FIG. 2, compiler 200 may include a front-end 210 configured to receive and analyze the source code 212 in the source language.

In some demonstrative aspects, front-end 210 may be configured to generate an intermediate code 213, for example, based on the source code 212.

In some demonstrative aspects, intermediate code 213 may include a lower level representation of the source code 212.

In some demonstrative aspects, front-end 210 may be configured to perform, for example, lexical analysis, syntax analysis, semantic analysis, and/or any other additional or alternative type of analysis, of the source code 212.

In some demonstrative aspects, front-end 210 may be configured to identify errors and/or problems with an outcome of the analysis of the source code 212. For example, front-end 210 may be configured to generate error information, e.g., including error and/or warning messages, for example, which may identify a location in the source code 212, for example, where an error or a problem is detected.

In some demonstrative aspects, as shown in FIG. 2, compiler 200 may include a middle-end 220 configured to receive and process the intermediate code 213, and to generate an adjusted, e.g., optimized, intermediate code 223.

In some demonstrative aspects, middle-end 220 may be configured to perform one or more adjustment, e.g., optimizations, to the intermediate code 213, for example, to generate the adjusted intermediate code 223.

In some demonstrative aspects, middle-end 220 may be configured to perform the one or more optimizations on the intermediate code 213, for example, independent of a type of the target computer to execute the target code 233.

In some demonstrative aspects, middle-end 220 may be implemented to support use of the optimized intermediate code 223, for example, for different machine types.

In some demonstrative aspects, middle-end 220 may be configured to optimize the intermediate representation of the intermediate code 223, for example, to improve performance and/or quality of the produced target code 233.

In some demonstrative aspects, the one or more optimizations of the intermediate code 213, may include, for example, inline expansion, dead-code elimination, constant propagation, loop transformation, parallelization, and/or the like.

In some demonstrative aspects, as shown in FIG. 2, compiler 200 may include a back-end 230 configured to receive and process the adjusted intermediate code 213, and to generate the target code 233 based on the adjusted intermediate code 213.

In some demonstrative aspects, back-end 230 may be configured to perform one or more operations and/or processes, which may be specific for the target computer to execute the target code 233. For example, back-end 230 may be configured to process the optimized intermediate code 213 by applying to the adjusted intermediate code 213 analysis, transformation, and/or optimization operations, which may be configured, for example, based on the target computer to execute the target code 233.

In some demonstrative aspects, the one or more analysis, transformation, and/or optimization operations applied to the adjusted intermediate code 213 may include, for example, resource and storage decisions, e.g., register allocation, instruction scheduling, and/or the like.

In some demonstrative aspects, the target code 233 may include target-dependent assembly code, which may be specific to the target computer and/or a target operating system of the target computer, which is to execute the target code 233.

In some demonstrative aspects, the target code 233 may include target-dependent assembly code for a processor, e.g., vector processor 180 (FIG. 1).

In some demonstrative aspects, compiler 200 may include a Vector Micro-Code Processor (VMP) Open Computing Language (OpenCL) compiler, e.g., as described below. In other aspects, compiler 200 may include, or may be implemented as part of, any other type of vector processor compiler.

In some demonstrative aspects, the VMP OpenCL compiler may include a Low Level Virtual Machine (LLVM) based (LLVM-based) compiler, which may be configured according to an LLVM-based compilation scheme, for example, to lower OpenCL C-code to VMP accelerator assembly code, e.g., suitable for execution by vector processor 180 (FIG. 1).

In some demonstrative aspects, compiler 200 may include one or more technologies, which may be required to compile code to a format suitable for a VMP architecture, e.g., in addition to open-sourced LLVM compiler passes.

In some demonstrative aspects, FE 210 may be configured to parse the OpenCL C-code and to translate it, e.g., through an Abstract Syntax Tree (AST), for example, into an LLVM Intermediate Representation (IR).

In some demonstrative aspects, compiler 200 may include a dedicated API, for example, to detect a correct pattern for compiler pattern matching, for example, suitable for the VMP. For example, the VMP may be configured as a Complex Instruction Set Computer (CISC) machine implementing a very complex Instruction Set Architecture (ISA), which may be hard to target from standard C code. Accordingly, compiler pattern matching may not be able to easily detect the correct pattern, and for this case the compiler may require a dedicated API.

In some demonstrative aspects, FE 210 may implement one or more vendor extension built-ins, which may target VMP-specific ISA, for example, in addition to standard OpenCL built-ins, which may be optimized to a VMP machine.

In some demonstrative aspects, FE 210 may be configured to implement OpenCL structures and/or work item functions.

In some demonstrative aspects, ME 220 may be configured to process LLVM IR code, which may be general and target-independent, for example, although it may include one or more hooks for specific target architectures.

In some demonstrative aspects, ME 220 may perform one or more custom passes, for example, to support the VMP architecture, e.g., as described below.

In some demonstrative aspects, ME 220 may be configured to perform one or more operations of a Control Flow Graph (CFG) Linearization analysis, e.g., as described below.

In some demonstrative aspects, the CFG Linearization analysis may be configured to linearize the code, for example, by converting if-statements to select patterns, for example, in case VMP vector code does not support standard control flow.

In one example, ME 220 may receive a given code, e.g., as follows:

| If (x > 0) { | |
|---|---|
| | A = A + 5; |
| } else | { |
| | B = B * 2; |

}

According to this example, ME 220 may be configured to apply the CFG Linearization analysis to the given code, e.g., as follows:

tmpA = A + 5;
tmpB = B * 2;
mask = x > 0;
A = Select mask, tmpA, A
B = Select not mask, tmpB, B

### Example (1)

In some demonstrative aspects, ME 220 may be configured to perform one or more operations of an auto-vectorization analysis, e.g., as described below.

In some demonstrative aspects, the auto-vectorization analysis may be configured to vectorize, e.g., auto-vectorize, a given code, e.g., to utilize vector capabilities of the VMP.

In some demonstrative aspects, ME 220 may be configured to perform the auto-vectorization analysis, for example, to vectorize code in a scalar form. For example, some or all operations of the auto-vectorization analysis may not be performed, for example, in case the code is already provided in a vectorized form.

In some demonstrative aspects, for example, in some use cases and/or scenarios, a compiler may not always be able to auto-vectorize a code, for example, due to data dependencies between loop iterations.

In one example, ME 220 may receive a given code, e.g., as follows:

char* a,b,c;
for (int i=0; i < 2048; i++) {
a[i]=b[i]+c[i];
}

According to this example, ME 220 may be configured to perform the CFG auto-vectorization analysis by applying a first conversion, e.g., as follows:

char* a,b,c;
for (int i=0; i < 2048; i+=32) {
a[i.i+31]=b[i...i+31]+c[i...i+31];
}

### Example (2a)

For example, ME 220 may be configured to perform the CFG auto-vectorization analysis by applying a second conversion, for example, following the first conversion, e.g., as follows:

char32* a,b,c;
for (int i=0; i < 64; i++) {
a[i]=b[i]+c[i];
}

### Example (2b)

In some demonstrative aspects, ME 220 may be configured to perform one or more operations of a Scratch Pad Memory Loop Access Analysis (SPMLAA), e.g., as described below.

In some demonstrative aspects, the SPMLAA may define Processing Blocks (PB), e.g., that should be outlined and compiled for VMP later.

In some demonstrative aspects, the processing blocks may include accelerated loops, which may be executed by the vector unit of the VMP.

In some demonstrative aspects, a PB, e.g., each PB, may include memory references. For example, some or all memory accesses may refer to local memory banks.

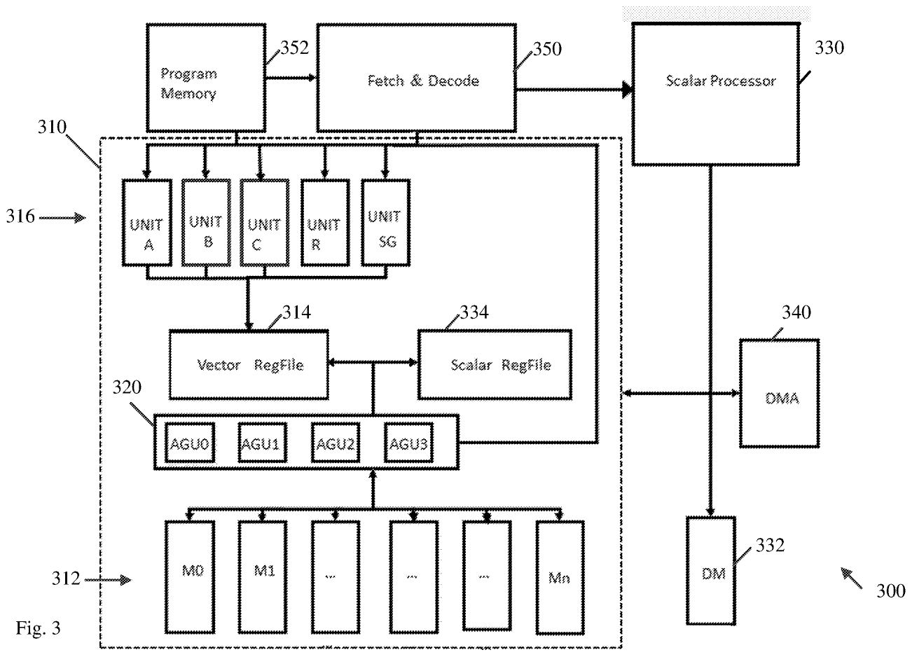

In some demonstrative aspects, the VMP may enable access to memory banks through AGUs, e.g., AGUs 320 as described below with reference to FIG. 3, and Scatter Gather units (SG).

In some demonstrative aspects, the AGUs may be pre-configured, e.g., before loop execution. For example, a loop trip count may be calculated, e.g., ahead of running a processing block.

In some demonstrative aspects, image references, e.g., some or all image references, may be created at this stage, and may be followed by calculation of strides and offsets, e.g., per dimension for each reference.

In some demonstrative aspects, ME 220 may be configured to perform one or more operations of an AGU planner analysis, e.g., as described below.

In some demonstrative aspects, the AGU Planner analysis may include iterator assignment, which may cover image references, e.g., all image references, from the entire Processing Block.

In some demonstrative aspects, an iterator may cover a single reference or a group of references.

In some demonstrative aspects, one or more memory references may be coalesced and/or reuse a same access through shuffle instructions, and/or saving values read from previous iterations.

In some demonstrative aspects, other memory references, e.g., which have no linear access pattern, may be handled using a Scatter-Gather (SG) unit, which may have a performance penalty, e.g., as it may require maintaining indices and/or masks.

In some demonstrative aspects, a plan may be configured as an arrangement of iterators in a processing block. For example, a processing block may have multiple plans, e.g., theoretically.

In some demonstrative aspects, the AGU Planner analysis may be configured to build all possible plans for all PBs, and to select a combination, e.g., a best combination, e.g., from all valid combinations.

In some demonstrative aspects, a total number of iterators in a valid combination may be limited, e.g., not to exceed a number of available AGUs on a VMP.

In some demonstrative aspects, one or more parameters, e.g., including stride, width and/or base, may be defined for an iterator, e.g., for each iterator for example, as part of the AGU Planner analysis. For example, min-max ranges for the iterators may be defined in a dimension, e.g., in each dimension, for example, as part of the AGU Planner analysis.

In some demonstrative aspects, the AGU Planner analysis may be configured to track and evaluate a memory reference, e.g., each memory reference, to an image, e.g., to understand its access pattern.

In one example, according to Examples 2a/2b, the image ‘a’ which is the base address, may be accessed with steps of 32 bytes for 64 iterations.

In some demonstrative aspects, the LLVM may include a scalar evaluation analysis (SCEV), which may compute an access pattern, e.g., to understand every image reference.

In some demonstrative aspects, ME 220 may utilize masking capabilities of the AGUs, for example, to avoid maintaining an induction variable, which may have a performance penalty.

In some demonstrative aspects, ME 220 may be configured to perform one or more operations of a rewrite analysis, e.g., as described below.

In some demonstrative aspects, the rewrite analysis may be configured to transform the code of a processing block, for example, while setting iterators and/or modifying memory access instructions.

In some demonstrative aspects, setting of the iterators, e.g., of all iterators, may be implemented in IR in target-specific intrinsics. For example, the setting of the iterators may reside in a pre-header of an outermost loop.

In some demonstrative aspects, the rewrite analysis may include loop-perfectization analysis, e.g., as described below.

In some demonstrative aspects, the code may be compiled with a target that substantially all calculations should be executed inside the innermost loop.

For example, the loop-perfectization analysis may hoist instructions, e.g., to move into a loop an operation performed after a last iteration of the loop.

For example, the loop-perfectization analysis may sink instructions, e.g., to move into a loop an operation performed before a first iteration of the loop.

For example, the loop-perfectization analysis may hoist instructions and/or sink instructions, for example, such that substantially all instructions are moved from outer loops to the innermost loops.

For example, the loop-perfectization analysis may be configured to provide a technical solution to support VMP iterators, e.g., to work on perfectly nested loops only.

For example, the loop-perfectization analysis may result in a situation where there are no instructions between the “for” statements that compose the loop, e.g., to support VMP iterators, which cannot emulate such cases.

In some demonstrative aspects, the loop-perfectization analysis may be configured to collapse a nested loop into a single collapsed loop.

In one example, ME 220 may receive a given code, e.g., as follows:

```
for (int i = 0; i < N; i++) {
  int sum = 0;
  for (int j = 0; j < M; j++)
  {
    sum += a[j + stride * i];
  }
    res[i] = sum;
}
```

According to this example, ME 220 may be configured to perform the loop-perfectization analysis to collapse the nested loop in the code to a single collapsed loop, e.g., as follows:

```
for (int k = 0; k < N * M; k++) {
  sum = (k % M == 0 ? 0 : sum);
  sum += a[k % M + stride * ( k / M )];
    res[k/M] = sum;
}
```

### Example (3)

In some demonstrative aspects, ME 220 may be configured to perform one or more operations of a Vector Loop Outlining analysis, e.g., as described below.

In some demonstrative aspects, the Vector Loop Outlining analysis may be configured to divide a code between a scalar subsystem and a vector subsystem, e.g., vector processing block 310 (FIG. 3) and scalar processor 330 (FIG. 3) as described below with reference to FIG. 3.

In some demonstrative aspects, the VMP accelerator may include the scalar and/or vector subsystems, e.g., as described below. For example, each of the subsystems may have different compute units/processors. Accordingly, a scalar code may be compiled on a scalar compiler, e.g., an SSC compiler, and/or an accelerated vector code may run on the VMP vector processor.

In some demonstrative aspects, the Vector Loop Outlining analysis may be configured to create a separate function for a loop body of the accelerated vector code. For example, these functions may be marked for the VMP and/or may continue to the VMP backend, for example, while the rest of the code may be compiled by the SSC compiler.

In some demonstrative aspects, one or more parts of a vector loop, e.g., configuration of the vector unit and/or initialization of vector registers, may be performed by a scalar unit. However, these parts may be performed in a later stage, for example, by performing backpatching into the scalar code, e.g., as the scalar code may still be in LLVM IR before processing by the SSC compiler.

In some demonstrative aspects, BE 230 may be configured to translate the LLVM IR into machine instructions. For example, the BE 230 may not be target agnostic and may be familiar with target-specific architecture and optimizations, e.g., compared to ME 220, which may be agnostic to a target-specific architecture.

In some demonstrative aspects, BE 230 may be configured to perform one or more analyses, which may be specific to a target machine, e.g., a VMP machine, to which the code is lowered, e.g., although BE 230 may use common LLVM.

In some demonstrative aspects, BE 230 may be configured to perform one or more operations of an instruction lowering analysis, e.g., as described below.

In some demonstrative aspects, the instruction lowering analysis may be configured to translate LLVM IR into target-specific instructions Machine IR (MIR), for example, by translating the LLVM IR into a Directed Acyclic Graph (DAG).

In some demonstrative aspects, the DAG may go through a legalization process of instructions, for example, based on the data types and/or VMP instructions, which may be supported by a VMP HW.

In some demonstrative aspects, the instruction lowering analysis may be configured to perform a process of pattern-matching, e.g., after the legalization process of instructions, for example, to lower a node, e.g., each node, in the DAG, for example, into a VMP-specific machine instruction.

In some demonstrative aspects, the instruction lowering analysis may be configured to generate the MIR, for example, after the process of pattern-matching.

In some demonstrative aspects, the instruction lowering analysis may be configured to lower the instruction according to machine Application Binary Interface (ABI) and/or calling conventions.

In some demonstrative aspects, BE 230 may be configured to perform one or more operations of a unit balancing analysis, e.g., as described below.

In some demonstrative aspects, the unit balancing analysis may be configured to balance instructions between VMP compute units, e.g., data processing units 316 (FIG. 3) as described below with reference to FIG. 3.

In some demonstrative aspects, the unit balancing analysis may be familiar with some or all available arithmetic transformations, and/or may perform transformations according to an optimal algorithm.

In some demonstrative aspects, BE 230 may be configured to perform one or more operations of a modulo scheduler (pipeliner) analysis, e.g., as described below.

In some demonstrative aspects, the pipeliner may be configured to schedule the instructions according to one or more constraints, e.g., data dependency, resource bottlenecks and/or any other constrains, for example, using Swing Modulo Scheduling (SMS) heuristics and/or any other additional and/or alternative heuristic.

In some demonstrative aspects, the pipeliner may be configured to schedule a set, e.g., an Initiation Interval (II), of Very Long Instruction Word (VLIW) instructions that the program will iterate on, e.g., during a steady state.

In some demonstrative aspects, a performance metric, which may be based on a number of cycles a typical loop may execute, may be measured, e.g., as follows:

(Size of Input data in bytes)*II/(Bytes consumed/produced every iteration)

In some demonstrative aspects, the pipeliner may try to minimize the II, e.g., as much as possible, for example, to improve performance.

In some demonstrative aspects, the pipeliner may be configured to calculate a minimum II, and to schedule accordingly. For example, if the pipeliner fails the scheduling, the pipeliner may try to increase the II and retry scheduling, e.g., until a predefined II threshold is violated.

In some demonstrative aspects, BE 230 may be configured to perform one or more operations of a register allocation analysis, e.g., as described below.

In some demonstrative aspects, the register allocation analysis may be configured to attempt to assign a register in an efficient, e.g., optimal, way.

In some demonstrative aspects, the register allocation analysis may assign values to bypass vector registers, general purpose vector registers, and/or scalar registers.

In some demonstrative aspects, the values may include private variables, constants, and/or values that are rotated across iterations.

In some demonstrative aspects, the register allocation analysis may implement an optimal heuristic that suites one or more VMP register file (regfile) constraints. For example, in some use cases, the register allocation analysis may not use a standard LLVM register allocation.

In some demonstrative aspects, in some cases, the register allocation analysis may fail, which may mean that the loop cannot be compiled. Accordingly, the register allocation analysis may implement a retry mechanism, which may go back to the modulo scheduler and may attempt to reschedule the loop, e.g., with an increased initiation interval. For example, increasing the initiation interval may reduce register pressure, and/or may support compilation of the vector loop, e.g., in many cases.

In some demonstrative aspects, BE 230 may be configured to perform one or more operations of an SSC configuration analysis, e.g., as described below.

In some demonstrative aspects, the SSC configuration analysis may be configured to set a configuration to execute the kernel, e.g., the AGU configuration.

In some demonstrative aspects, the SSC configuration analysis may be performed at a late stage, for example, due to configurations calculated after legalization, the register allocation analysis, and/or the modulo scheduling analysis.

In some demonstrative aspects, the SSC configuration analysis may include a Zero Overhead Loop (ZOL) mechanism in the vector loop. For example, the ZOL mechanism may configure a loop trip count based on an access pattern of the memory references in the loop, for example, to avoid running instructions that check the loop exit condition every iteration.

In some demonstrative aspects, a VMP Compilation Flow may include one or more, e.g., a few, steps, which may be invoked during the compilation flow in a test library (testlib), e.g., a wrapper script for compilation, execution, and/or program testing. For example, these steps may be performed outside of the LLVM Compiler.

In some demonstrative aspects, a PCB Hardware Description Language (PHDL) simulator may be implemented to perform one or more roles of an assembler, encoder, and/or linker.

In some demonstrative aspects, compiler 200 may be configured to provide a technical solution to support robustness, which may enable compilation of a vast selection of loops, with HW limitations. For example, compiler 200 may be configured to support a technical solution, which may not create verification errors.

In some demonstrative aspects, compiler 200 may be configured to provide a technical solution to support programmability, which may provide a user an ability to express code in multiple ways, which may compile correctly to the VMP architecture.

In some demonstrative aspects, compiler 200 may be configured to provide a technical solution to support an improved user-experience, which may allow the user capability to debug and/or profile code. For example, the improved user-experience may provide informative error messages, report tools, and/or a profiler.

In some demonstrative aspects, compiler 200 may be configured to provide a technical solution to support improved performance, for example, to optimize a VMP assembly code and/or iterator accesses, which may lead to a faster execution. For example, improved performance may be achieved through high utilization of the compute units and usage of its complex CISC.

Reference is made to FIG. 3, which schematically illustrates a vector processor 300, in accordance with some demonstrative aspects. For example, vector processor 180 (FIG. 1) may be implement one or more elements of vector processor 300, and/or may perform one or more operations and/or functionalities of vector processor 300.

In some demonstrative aspects, vector processor 300 may include a Vector Microcode Processor (VMP).

In some demonstrative aspects, vector processor 300 may include a Wide Vector machine, for example, supporting Very Long Instruction Word (VLIW) architectures, and/or Single Instruction/Multiple Data (SIMD) architectures.

In some demonstrative aspects, vector processor 300 may be configured to provide a technical solution to support high performance for short integral types, which may be common, for example, in computer-vision and/or deep-learning algorithms.

In other aspects, vector processor 300 may include any other type of vector processor, and/or may be configured to support any other additional or alternative functionalities.

In some demonstrative aspects, as shown in FIG. 3, vector processor 300 may include a vector processing block (vector processor) 310, a scalar processor 330, and a Direct Memory Access (DMA) 340, e.g., as described below.

In some demonstrative aspects, as shown in FIG. 3, vector processing block 310 may be configured to process, e.g., efficiently process, image data and/or vector data. For example, the vector processing block 310 may be configured to use vector computation units, for example, to speed up computations.

In some demonstrative aspects, scalar processor 330 may be configured to perform scalar computations. For example, the scalar processor 330 may be used as a “glue logic” for programs including vector computations. For example, some, e.g., even most, of the computation of the programs may be performed by the vector processing block 310. However, several tasks, for example, some essential tasks, e.g., scalar computations, may be performed by the scalar processor 330.

In some demonstrative aspects, the DMA 340 may be configured to interface with one or more memory elements in a chip including vector processor 300.

In some demonstrative aspects, the DMA 340 may be configured to read inputs from a main memory, and/or write outputs to the main memory.

In some demonstrative aspects, the scalar processor 330 and the vector processing block 310 may use respective local memories to process data.

In some demonstrative aspects, as shown in FIG. 3, vector processor 300 may include a fetcher and decoder 350, which may be configured to control the scalar processor 330 and/or the vector processing block 310.

In some demonstrative aspects, operations of the scalar processor 330 and/or the vector processing block 310 may be triggered by instructions stored in a program memory 352.

In some demonstrative aspects, the DMA 340 may be configured to transfer data, for example, in parallel with the execution of the program instructions in memory 352.

In some demonstrative aspects, DMA 340 may be controlled by software, e.g., via configuration registers, for example, rather than instructions, and, accordingly, may be considered as a second “thread” of execution in vector processor 300.

In some demonstrative aspects, the scalar processor 330, the vector processing block 310, and/or the DMA 340 may include one or more data processing units, for example, a set of data processing units, e.g., as described below.

In some demonstrative aspects, the data processing units may include hardware configured to preform computations, e.g., an Arithmetic Logic Unit (ALU).

In one example, a data processing unit may be configured to add numbers, and/or to store the numbers in a memory.

In some demonstrative aspects, the data processing units may be controlled by commands, e.g., encoded in the program memory 352 and/or in configuration registers. For example, the configuration registers may be memory mapped, and may be written by the memory store commands of the scalar processor 330.

In some demonstrative aspects, the scalar processor 330, the vector processing block 310, and/or the DMA 340 may include a state configuration including a set of registers and memories, e.g., as described below.

In some demonstrative aspects, as shown in FIG. 3, vector processor block 310 may include a set of vector memories 312, which may be configured, for example, to store data to be processed by vector processor block 310.

In some demonstrative aspects, as shown in FIG. 3, vector processor block 310 may include a set of vector registers 314, which may be configured, for example, to be used in data processing by vector processor block 310.

In some demonstrative aspects, the scalar processor 330, the vector processing block 310, and/or the DMA 340 may be associated with a set of memory maps.

In some demonstrative aspects, a memory map may include a set of addresses accessible by a data processing unit, which may load and/or store data from/to registers and memories.

In some demonstrative aspects, as shown in FIG. 3, the vector processing block 310 may include a plurality of Address Generation Units (AGUs) 320, which may include addresses accessible to them, e.g., in one or more of memories 312.

In some demonstrative aspects, as shown in FIG. 3, vector processor block 310 may include a plurality of data processing units 316, e.g., as described below.

In some demonstrative aspects, data processing units 316 may be configured to process commands, e.g., including several numbers at a time. In one example, a command may include 8 numbers. In another example, a command may include 4 numbers, 16 numbers, or any other count of numbers.

In some demonstrative aspects, two or more data processing units 316 may be used simultaneously. In one example, data processing units 316 may process and execute a plurality of different command, e.g., 3 different commands, for example, including 8 numbers, at a throughout of a single cycle.

In some demonstrative aspects, data processing units 316 may be asymmetrical. For example, first and second data processing units 316 may support different commands. For example, addition may be performed by a first data processing unit 316, and/or multiplication may be performed by a second data processing unit 316. For example, both operations may be performed by one or more additional other data processing units 316.

In some demonstrative aspects, data processing units 316 may be configured to support arithmetic operations for many combinations of input & output data types.

In some demonstrative aspects, data processing units 316 may be configured to support one or more operations, which may be less common. For example, processing units 316 may support operations working with a Look Up Table (LUT) of vector processor 300, and/or any other operations.

In some demonstrative aspects, data processing units 316 may be configured to support efficient computation of non-linear functions, histograms, and/or random data access, e.g., which may be useful to implement algorithms like image scaling, Hough transforms, and/or any other algorithms.

In some demonstrative aspects, vector memories 312 may include, for example, memory banks having a size of 16K or any other size, which may be accessed at a same cycle.

In one example, a maximal memory access size may be 64 bits. According to this example, a peak throughput may be 256 bits, e.g., 64×4=256. For example, high memory bandwidth may be implemented to utilize computation capabilities of the data processing units 316.

In one example, two data processing units 316 may support 16 8-bit multiply & accumulate operations (MACs) per cycle. According to this example, the two data processing units 316 may not be useful, for example, in case the input numbers are not fetched at this speed, and/or there isn't exactly 256 bits of input, e.g., 16×8×2=256.

In some demonstrative aspects, AGUs 320 may be configured to perform memory access operations, e.g., loading and storing data from/to vector memories 314.

In some demonstrative aspects, AGUs 320 may be configured to compute addresses of input and output data items, for example, to handle I/O to utilize the data processing units 316, e.g., in case sheer bandwidth is not enough.

In some demonstrative aspects, AGUs 320 may be configured to compute the addresses of the input and/or output data items, for example, based on configuration registers written by the scalar processor 330, for example, before a block of vector commands, e.g., a loop, is entered.

For example, AGUs 320 may be configured to write an image base pointer, a width, a height and/or a stride to the configuration registers, for example, in order to iterate over an image.

In some demonstrative aspects, AGUs 320 may be configured to handle addressing, e.g., all addressing, for example, to provide a technical solution in which data processing units 316 may not have the burden of incrementing pointers or counters in a loop, and/or the burden to check for end-of-row conditions, e.g., to zero a counter in the loop.

In some demonstrative aspects, as shown in FIG. 3, AGUs 320 may include 4 AGUs, and, accordingly, four memories 312 may be accessed at a same cycle. In other aspects, any other count of AGUs 32 may be implemented.

In some demonstrative aspects, AGUs 320 may not be “tied” to memory banks 312. For example, an AGU 320, e.g., each AGU 320, may access a memory bank 312, e.g., every memory bank 312, for example, as long as two or more AGUs 320 do not try to access the same memory bank 312 at the same cycle.

In some demonstrative aspects, vector registers 314 may be configured to support communication between the data processing units 316 and AGUs 320.

In one example, a total number of vector registers 314 may be 28, which may be divided into several subsets, e.g., based on their function. For example, a first subset of vector registers 314 may be used for inputs/outputs, e.g., of all data processing units 316 and/or AGUs 320; and/or a second subset of vector registers 314 may not be used for outputs of some operations, e.g., most operations, and may be used for one or more other operations, e.g., to store loop-invariant inputs.

In some demonstrative aspects, a data processing unit 316, e.g., each data processing unit 316, may have one or more registers to host an output of a last executed operation, e.g., which may be fed as inputs to other data processing units 316. For example, these registers may “bypass” the vector registers 314, and may work faster than writing these outputs to first set of vector registers 314.

In some demonstrative aspects, fetcher and decoder 350 may be configured to support low-overhead vector loops, e.g., very low overhead vector loops (also referred to as “zero-overhead vector loops”), for example, where there may be no need to check a termination (exit) condition of a vector loop during an execution of the vector loop.

For example, a termination (exit) condition may be signaled by an AGU 320, for example, when the AGU 320 finishes iterating over a configured memory region.

For example, fetcher and decoder 350 may quit the loop, for example, when the AGU 320 signals the termination condition.

For example, the scalar processor 330 may be utilized to configure the loop parameters, e.g., first & last instructions and/or the exit condition.

In one example, vector loops may be utilized, for example, together with high memory bandwidth and/or cheap addressing, for example, to solve a control and data flow problem, for example, to provide a technical solution to allow the data processing units 316 to process data, e.g., without substantially additional overhead.

In some demonstrative aspects, scalar processor 330 may be configured to provide one or more functionalities, which may be complementary to those of the vector processing block 310. For example, a large portion, e.g., most, of the work in a vector program may be performed by the data processing units 316. For example, the scalar processor 330 may be utilized, for example, for “gluing” together the various blocks of vector code of the vector program.

In some demonstrative aspects, scalar processor 330 may be implemented separately from vector processing block 310. In other aspects, scalar processor 330 may be configured to share one or more components and/or functionalities with vector processing block 310.

In some demonstrative aspects, scalar processor 330 may be configured to perform operations, which may not be suitable for execution on vector processing block 310.

For example, scalar processor 330 may be utilized to execute 32 bit C programs. For example, scalar processor 330 may be configured to support 1, 2, and/or 4 byte data types of C code, and/or some or all arithmetic operators of C code.

For example, scalar processor 330 may be configured to provide a technical solution to perform operations that cannot be executed on vector processing block 310, for example, without using a full-blown CPU.

In some demonstrative aspects, scalar processor 330 may include a scalar data memory 332, e.g., having a size of 16K or any other size, which may be configured to store data, e.g., variables used by the scalar parts of a program.

For example, scalar processor 330 may store local and/or global variables declared by portable C code, which may be allocated to scalar data memory by a compiler, e.g., compiler 200 (FIG. 2).

In some demonstrative aspects, as shown in FIG. 3, scalar processor 330 may include, or may be associated with, a set of vector registers 334, which may be used in data processing performed by the scalar processor 330.

In some demonstrative aspects, scalar processor 330 may be associated with a scalar memory map, which may support scalar processor 330 in accessing substantially all states of vector processor 300. For example, the scalar processor 330 may configure the vector units and/or the DMA channels via the scalar memory map.

In some demonstrative aspects, scalar processor 330 may not be allowed to access one or more block control registers, which may be used by external processors to run and debug vector programs.

In some demonstrative aspects, DMA 340 may be configured to communicate with one or more other components of a chip implementing the vector processor 300, for example, via main memory. For example, DMA 340 may be configured to transfer blocks of data, e.g., large, contiguous, blocks of data, for example, to support the scalar processor 330 and/or the vector processing block, which may manipulate data stored in the local memories. For example, a vector program may be able to read data from the main chip memory using DMA 340.

In some demonstrative aspects, DMA 340 may be configured to communicate with other elements of the chip, for example, via a plurality of DMA channels, e.g., 8 DMA channels or any other count of DMA channels. For example, a DMA channel, e.g., each DMA channel, may be capable of transferring a rectangular patch from the local memories to the main chip memory, or vice versa. In other aspects, the DMA channel may transfer any other type of data block between the local memories and the main chip memory.

In some demonstrative aspects, a rectangular patch may be defined by a base pointer, a width, a height, and astride.

For example, at peak throughput, 8 bytes per cycle may be transferred, however, there may be overheads for each patch and/or for each row in a patch.

In some demonstrative aspects, DMA 340 may be configured to transfer data, for example, in parallel with computations, e.g., via the plurality of DMA channels, for example, as long as executed commands do not access a local memory involved in the transfer.

In one example, as all channels may access the same memory bus, using several channels to implement a transfer may not save I/O cycles, e.g., compared to the case when a single channel is used. However, the plurality of DMA channels may be utilized to schedule several transfers and execute them in parallel with computations. This may be advantageous, for example, compared to a single channel, which may not allow scheduling a second transfer before completion of the first transfer.

In some demonstrative aspects, DMA 340 may be associated with a memory map, which may support the DMA channels in accessing vector memories and/or the scalar data. For example, access to the vector memories may be performed in parallel with computations. For example, access to the scalar data may usually not be allowed in parallel, e.g., as the scalar processor 330 may be involved in almost any sensible program, and may likely access it's local variables while the transfer is performed, which may lead to a memory contention with the active DMA channel.

In some demonstrative aspects, DMA 340 may be configured to provide a technical solution to support parallelization of I/O and computations. For example, a program performing computations may not have to wait for I/O, for example, in case these computations may run fast by vector processing block 310.

In some demonstrative aspects, an external processor, e.g., a CPU, may be configured to initiate execution of a program on vector processor 300. For example, vector processor 300 may remain idle, e.g., as long as program execution is not initiated.

In some demonstrative aspects, the external processor may be configured to debug the program, e.g., execute a single step at a time, halt when the program reaches breakpoints, and/or inspect contents of registers and memories storing the program variables.

In some demonstrative aspects, an external memory map may be implemented to support the external processor in controlling the vector processor 300 and/or debugging the program, for example, by writing to control registers of the vector processor 300.

In some demonstrative aspects, the external memory map may be implemented by a superset of the scalar memory map. For example, this implementation may make all registers and memories defined by the architecture of the vector processor 300 accessible to a debugger back-end running on the external processor.

In some demonstrative aspects, the vector processor 300 may raise an interrupt signal, for example, when the vector processor 300 terminates a program.

In some demonstrative aspects, the interrupt signal may be used, for example to implement a driver to maintain a queue of programs scheduled for execution by the vector processor 300, and/or to launch a new program, e.g., by the external processor, for example, upon the completion of a previously executed program.

Referring back to FIG. 1, in some demonstrative aspects, compiler 160 may be configured to generate the target code 115 based on one or more loops, which may be based, for example, on source code 112, e.g., as described below.

In some demonstrative aspects, compiler 160 may be configured to compile one or more operations according a compilation scheme, which may be configured to provide a technical solution to reduce usage of select instructions, for example, select-mask instructions, e.g., as described below.

In some demonstrative aspects, a select-mask instruction may include a an instruction to select between a first value and a second value, for example, according to a mask, e.g., as described below.

In some demonstrative aspects, a mask may include at least one condition, which may be based on, and/or may represent, for example, a result of a compare operation.

In some demonstrative aspects, a mask may include a Boolean mask representing a Boolean condition, or a vector of Boolean conditions, which may be based on, and/or may represent, for example, a result of a compare operation.

In some demonstrative aspects, an operation based on a mask (also referred to as “masked operation”) may include a conditional operation, which may be based on whether the mask is true or false.

For example, the mask may be implemented as a vector-mask, which may include a plurality of elements, which may be configured to indicate whether true or false mask states. In one example, a mask element may be set to a first value, e.g., “1”, to indicate a true masked state, or to a second value, e.g., “0”, to indicate a false mask state.

For example, a masked operation may be executed based on a vector-mask, for example, by selectively executing the operation based on the vector-mask.

For example, the masked operation may be executed based on a vector-mask, for example, by selecting to execute the operation with respect to one or more inputs corresponding to mask elements set to “1”, and by selecting not to execute the operation with respect to one or more inputs corresponding to mask elements set to “0”.

In one example, given a vector-mask [1,1,1,0], the first three elements may be set, e.g., (true), and the last element, e.g., a fourth element, may be unset, e.g., (false). According to this example, a vector operation based on the mask, e.g., a masked load operation and/or any other suitable operation, may be executed, for example, by selectively executing the operation on the first 3 lanes, and not executing the operation on a 4th lane, e.g., such that the 4th lane may be “masked out”.

For example, a masked operation may define a default value (“passthrough”), which may be provided when the mask is unset, e.g., when a mask element is set to zero (false), for example, instead of the masked-out lane.

In one example, a masked-load operation may define a default value (“passthrough”), which may be provided when the mask is unset, for example, instead of the masked-out lane.

In some demonstrative aspects, in some use cases, scenarios and/or implementations, some compilation operations, for example, loop transformations, e.g., loop-vectorization transformations, may introduce masks representing memory-access bounds (also referred to as “induction-based masks”), for example, to provide a technical solution to filter out out-of-bounds values/computations. For example, this filtering may be done, for example, by selecting, according to an IV-based mask, between loaded/computed values, and some default-values.

In some demonstrative aspects, for example, in some use cases, scenarios and/or implementations, computation of masks representing memory-access bounds may be computationally expensive, for example, as this computation may require maintaining an induction variable (IV), comparing the IV against some bound, and/or reserving mask-registers, e.g., as described below.

For example, in some use cases, scenarios and/or implementations, computing one or more select-masks may be computationally “painful”, for example, in case such select-masks are implemented by one or more target processor architectures, which may not have efficient means to maintain inductions. In one example, some target architectures may have other mechanisms, e.g., Hardware (HW) mechanisms, which may be configured to control an execution of a loop, and to control bounds of memory accesses (also referred to as “bounded loads/stores”).

In some demonstrative aspects, complier 160 may be configured to identify one or more masked-select operations based on source code 112, and to compile the identified masked-select operations according to a masked-select compilation mechanism, e.g., as described below.

In some demonstrative aspects, the masked-select compilation mechanism may be configured to provide a technical solution to mitigate, eliminate, exclude, and/or reduce a number of, one or more select instructions (select-mask instructions) in a loop, e.g., as described below.

In some demonstrative aspects, complier 160 may be configured to generate the target code 115 by compiling the source code 112, for example, according to the masked-select compilation mechanism, e.g., as described below.

In some demonstrative aspects, the masked-select compilation mechanism may be configured to provide a technical solution to exclude one or more select instructions from a loop based on the source code 112, e.g., as described below.

In some demonstrative aspects, the masked-select compilation mechanism may be configured to exclude a select instruction, for example, based on a determination that the select instruction is fed entirely by a load operation, e.g., as described below.

In some demonstrative aspects, the masked-select compilation mechanism may be configured to exclude the select instruction from the loop, for example, by folding a selection mask into a feeding load operation, for example, if possible, e.g., as described below.

In some demonstrative aspects, folding the select mask into the load instruction may provide a technical solution to reduce computational load to compute a select operation and a mask operation, e.g., as described below.

For example, in some use cases, scenarios, and/or implementations, the mask may be expensive to compute as part of the select-mask instruction, while the mask itself may be cheap to compute, e.g., as described below.

In one example, the mask may be relatively cheap to compute when the mask is implemented as part of a load operation, e.g., to load information from a memory, as described below.

In some demonstrative aspects, the masked-select compilation mechanism may be configured to provide a technical solution to eliminate an identified select instruction, e.g., as descried below.

In some demonstrative aspects, the masked-select compilation mechanism may be configured to provide a technical solution to support exploiting a “bounded load” feature, e.g., in one or more types of target processors supporting Active Vector Length (AVL) predication, e.g., as descried below.

In some demonstrative aspects, the masked-select compilation mechanism may be configured to provide a technical solution to support exploiting the “bounded load” feature, for example, to avoid a mask computation, which may be computationally expensive, e.g., as described below.

In some demonstrative aspects, a processor, e.g., a vector processor, for example, processor 180, may be configured to utilize vector predicates, which may control which vector lanes are active.

In one example, an instruction, e.g., a “whilelt j,n” instruction or any other suitable type of instruction, may be used to set active lanes of a predicate register to true, e.g., based on a condition “while j<n”.

For example, a “bound mask” may be configured based on a bound of the predicate. In one example, the bound mask may have a form (j<bound).

In some demonstrative aspects, a processor, e.g., a vector processor, for example, processor 180, may be configured according to a vector processor architecture, e.g., a VMP architecture, where “bound masks” may be relatively cheap to compute, for example, when a bound mask is to mask a load operation.

For example, the bounds of a load operation (“bounded load”) may be configured before a loop including the bound mask.

In some demonstrative aspects, the masked-select compilation mechanism may be configured to provide a technical solution to support efficient “masked/predicated” accumulation, for example, in one or more target architectures that do not support predicated accumulation.

For example, in some use cases, implementations, and/or scenarios, a select instruction in a loop may be used to select for one or more lanes, e.g., for each lane, of a final sum, between a last-value and a one-before-last value.

For example, compiler 160 may be configured to utilize the masked-select compilation mechanism, for example, to avoid and/or exclude (drop) this select instruction.

For example, compiler 160 may be configured to utilize the masked-select compilation mechanism, for example, to configure a masked-load operation to apply a passthrough value, e.g., passthrough=0, to a load instruction, for example, instead of the select operation, e.g., as described below.

For example, compiler 160 may configure the masked-load operation to add one or more zeros to a sum operation, for example, according to the mask, e.g., instead of adding invalid values that would later be filtered away after the loop, e.g., as described below.

In some demonstrative aspects, the masked-select compilation mechanism may be configured to provide a technical solution to support one or more target processor architectures, for example, an AVX512 architecture and/or any other architecture, which may support masked load operations with a default value, e.g., as described below.

In some demonstrative aspects, the masked-select compilation mechanism may be configured to provide a technical solution to support one or more target processor architectures, which may utilize hardware-controlled loops with automatic upper-bound-mask generation, e.g., as described below.

In some demonstrative aspects, the masked-select compilation mechanism may be configured to provide a technical solution to support regular load operations, for example, by turning the regular load operations into masked loads, e.g., as described below.

In some demonstrative aspects, the masked-select compilation mechanism may be configured to provide a technical solution to simplify select-masks, for example, even in cases where only part of a mask may be folded into a load, e.g., as described below.

In some demonstrative aspects, compiler 160 may be configured to identify a select instruction in a loop operation, which may be based, for example, on the source code 112, e.g., as described below.

In some demonstrative aspects, the select instruction may include a select-mask instruction, e.g., as described below.

In some demonstrative aspects, the select instruction may be configured to select between a first value and a second value, for example, according to a mask in the select instruction, e.g., as described below.

In some demonstrative aspects, the first value in the identified select instruction may include a value of a vector variable having a size of the mask of the select instruction, e.g., as described below.

In some demonstrative aspects, the mask in the identified select instruction may include a mask vector, and the first value in the identified select instruction may include a value of a vector variable having, for example, a same size as the mask vector, e.g., as described below.

In some demonstrative aspects, compiler 160 may be configured to identify that the first value in the identified select instruction may be based on the same mask, which may be utilized by the identified select instruction, e.g., as described below.

In some demonstrative aspects, compiler 160 may be configured to configure a masked operation in the loop, for example, based on the identified select instruction, e.g., as described below.

In some demonstrative aspects, compiler 160 may be configured to configure the masked operation, for example, based on the mask in the select instruction, e.g., as described below.

In some demonstrative aspects, compiler 160 may be configured to configure the masked operation to utilize a mask, which may be based on the mask utilized in determining the first value in the identified select instruction, e.g., as described below.

In some demonstrative aspects, the masked operation may be configured to utilize the same mask, which is utilized in determining the first value in the identified select instruction, e.g., as described below.

In some demonstrative aspects, the first value in the identified select instruction may be based on a result of the mask implemented by the masked operation, e.g., as described below.

In some demonstrative aspects, compiler 160 may be configured to configure the masked operation to include a passthrough value, which may be defined, for example, based on the second value in the identified select instruction, e.g., as described below.

In some demonstrative aspects, compiler 160 may be configured to generate target code 115, for example, based on compilation of the source code 112, e.g., as described below.

In some demonstrative aspects, the target code 115 may be based on the masked operation, e.g., as described below.

In some demonstrative aspects, compiler 160 may be configured to generate the target code 115 configured, for example, for execution by a Very Long Instruction Word (VLIW) Single Instruction/Multiple Data (SIMD) target processor, e.g., processor 180.

In other aspects, compiler 160 may be configured to generate the target code 115 configured, for example, for execution by any other suitable type of processor.

In some demonstrative aspects, compiler 160 may be configured to generate the target code 115, for example, based on the source code 112 including Open Computing Language (OpenCL) code.

In other aspects, compiler 160 may be configured to generate the target code 115, for example, based on the source code 112 including any other suitable type of code.

In some demonstrative aspects, compiler 160 may be configured to compile the source code 112 into the target code 115, for example, according to a Low Level Virtual Machine (LLVM) based (LLVM-based) compilation scheme.

In other aspects, compiler 160 may be configured to compile the source code 112 into the target code 115 according to any other suitable compilation scheme.

In some demonstrative aspects, compiler 160 may be configured to exclude the identified select operation from the loop, e.g., as described below.

In some demonstrative aspects, compiler 160 may be configured to configure the masked operation to replace the identified select operation, e.g., as described below.

In some demonstrative aspects, compiler 160 may be configured to replace the identified select instruction with a reconfigured select instruction, e.g., as described below.

In some demonstrative aspects, the identified select instruction may be based on a first mask, and the reconfigured select instruction may include a select operation according to a second mask, e.g., different from the first mask, e.g., as described below.

In some demonstrative aspects, the first value in the identified select instruction may be based on the first mask, e.g., as described below.

In some demonstrative aspects, the reconfigured select instruction may include a select operation according to a simplified mask, which may be, for example, simplified relative to the mask in the identified select instruction, e.g., as described below.

In some demonstrative aspects, compiler 160 may be configured to configure the masked operation, for example, by reconfiguring an other masked operation in the loop, e.g., as described below.

In some demonstrative aspects, the other masked operation in the loop may include an undefined passthrough value, e.g., as described below.

In some demonstrative aspects, the other masked operation in the loop may include a default value of the select instruction, e.g., as described below.

In some demonstrative aspects, compiler 160 may be configured to configure the masked operation, for example, by reconfiguring a passthrough value of the other masked operation, e.g., as described below.

In some demonstrative aspects, compiler 160 may be configured to configure the masked operation, for example, by reconfiguring a passthrough value of the other masked operation, for example, based on the second value, e.g., as described below.

In some demonstrative aspects, compiler 160 may be configured to configure the masked operation, for example, by reconfiguring a passthrough value of the other masked operation based on one or more operations to be applied to a result of the other masked operation in the loop, e.g., as described below.

In some demonstrative aspects, the first value in the identified select instruction may be based on a result of the other masked operation, e.g., as described below.

In one example, compiler 160 may be configured to identify a loop operation including a select instruction and a first masked operation, and to reconfigure the first masked operation to provide a second masked operation, for example, based on the select instruction, e.g., as described below.

In other aspects, the other masked operation may be identified and/or configured based on any other additional or alternative parameter, attribute and/or criterion.

In some demonstrative aspects, compiler 160 may be configured to identify the select operation, for example, according to a criterion relating to a variation of a result of the masked operation through the loop, e.g., as described below.

In some demonstrative aspects, compiler 160 may be configured to identify the select operation, for example, according to a criterion relating to a variation of the second value in the identified select instruction through the loop, e.g., as described below.

In some demonstrative aspects, compiler 160 may be configured to identify the select operation, for example, based on a determination that the second value is invariant in the loop, e.g., as described below.

In some demonstrative aspects, compiler 160 may be configured to configure the passthrough value of the masked operation, for example, based on a variation of a result of the masked operation through the loop, e.g., as described below.

In some demonstrative aspects, compiler 160 may be configured to configure the passthrough value of the masked operation, for example, based on a determination that the passthrough value of the masked operation is invariant in the loop, e.g., as described below.

In some demonstrative aspects, compiler 160 may be configured to set the passthrough value of the masked operation, for example, to be equal to the second value in the identified select operation, e.g., as described below.

In some demonstrative aspects, compiler 160 may be configured to set the passthrough value of the masked operation, for example, to be equal to the second value in the identified select operation, for example, based on a determination that the passthrough value of the masked operation is invariant to the loop, e.g., as described below.

In some demonstrative aspects, compiler 160 may be configured to configure the passthrough value of the masked operation based, for example, on one or more operations in the loop, e.g., as described below.

In some demonstrative aspects, compiler 160 may be configured to identify one or more operations in the loop, which may affect the result of the masked operation, e.g., as described below.

In some demonstrative aspects, compiler 160 may be configured to configure the passthrough value of the masked operation, for example, based on the one or more identified operations, which may affect the result of the masked operation, e.g., as described below.

In some demonstrative aspects, compiler 160 may be configured to configure the passthrough value of the masked operation, for example, based on one or more operations to be applied to a result of the masked operation in the loop, e.g., as described below.

In some demonstrative aspects, compiler 160 may be configured to configure the passthrough value, for example, such that, the one or more identified operations, when applied to the result of the masked operation, may result in the second value in the identified select instruction, e.g., as described below.

In some demonstrative aspects, the masked operation may include a masked memory access operation, e.g., as described below.

In some demonstrative aspects, the masked operation may include a masked load operation to conditionally load values from a memory according to the mask, e.g., as described below.

In other embodiments, the masked operation may include any other type of masked operation.

In one example, compiler 160 may compile a source code 112 of a program to be executed by a target processor, e.g., processor 180.

For example, complier 160 may identify a loop including a select instruction based on source code 112, e.g., as follows:

```
for (I = 0; I < Align_Up(n,32); i++) {
  Bool4 mask = (I < n); // expensive computation
  Int4 loadedVal = masked.load ptr, mask, passthrough=undef //
  computing
    mask as part of the load is cheap: configured in advance
  Int4 val = mult (loadedVal, {2,2,2,2})
  filteredVal = Select mask, val, DefaultVal: Zero // computing mask as
    part of the select is expensive
  Use(filteredVal);
}
```

### Example (4a)

As shown in Example 4a, the loop may include a masked load operation, e.g., Int4 loadedVal=masked.load ptr, mask, passthrough=undef, including a mask and an undefined passthrough value, e.g., passthrough=undef.

As shown in Example 4a, the loop may include determining values of a vector variable, e.g., val, for example based on a multiplication instruction, e.g., Int4 Val=mult (loadedVal, {2,2,2,2}), which may be based on a result, e.g., loadedVal, of the masked load operation.

As shown in Example 4a, the loop may include a select instruction, e.g., filteredVal=Select mask, val, DefaultVal: Zero, to select between a first value, e.g., a value of the vector variable Val, and a second value, e.g., DefaultVal: Zero, for example, based on the mask of the masked load operation.

As shown in Example 4a, the first value Val may be based on the result loadedVal of the masked load operation.

As shown in Example 4a, the second value DefaultVal: Zero may be invariant in the loop.

In some demonstrative aspects, complier 160 may be configured to compile the loop, for example, based on the masked-select compilation mechanism, e.g., as described below.

In some demonstrative aspects, complier 160 may be configured to exclude the identified select operation from the loop, for example, by reconfiguring the masked load operation, e.g., as described below.

In some demonstrative aspects, complier 160 may reconfigure the masked load operation, for example, by setting the passthrough value of the reconfigured masked load operation to be equal to the second value DefaultVal: Zero of the identified select operation, e.g., as follows:

```
for (I =0; I < Align_Up(n,32); i++) {
  Bool4 mask = (I < n); // will not need to be computed in the loop, used
    only by the load
  Int4 loadedVal = masked.load ptr, mask, passthrough=zero // mask as
    part of the load is cheap, configured in advance
  Int4 val = mult (loadedVal, {2,2,2,2})
  Use(val); // the select became redundant
}
```

### Example (4b)

In some demonstrative aspects, as shown by Example 4b, the loop may include a reconfigured masked load operation, e.g., Int4 loadedVal=masked.load ptr, mask, passthrough=zero, including the passthrough equal to Zero.

In some demonstrative aspects, as shown by Example 4b, the passthrough may be set to a value, e.g., Zero, which may allow to perform the multiplication instruction, e.g., while excluding the select instruction. For example, the computation of the multiplication instruction may preserve the value passthrough=Zero set by the masked load operation according to the mask.

In some demonstrative aspects, as shown by Example 4b, the select instruction may become redundant, and may be entirely excluded from the loop, e.g., as a result of the setting the passthrough value to Zero.

In one example, compiler 160 may compile a source code 112 of another program to be executed by a target processor, e.g., processor 180.

For example, complier 160 may identify a loop including a select instruction based on source code 112, e.g., as follows:

```
  Int4 Sum = {0,0,0,0}; Int4 PrevSum;
  for (i = 0; i < Align_Up(n,4); i++) {
    Bool4 mask = (i < n); // expensive computation
    Int4 loadedVal = masked.load ptr, mask, passthrough=undef //
        computing mask as part of the load is cheap: configured in
        advance
    PrevSum = Sum;
    Sum += loadedVal; // may have added to Sum a few (undef) values
  }
Sum = Select mask, Sum, PrevSum // computing mask as part of the
      select is expensive
```

### Example (5a)

As shown in Example 5a, the loop may include a masked load operation, e.g., Int4 loadedVal=masked.load ptr, mask, passthrough=undef, including a mask and an undefined passthrough value, e.g., passthrough=undef.

As shown in Example 5a, the loop may include determining values of a vector variable, e.g., Sum, for example based on a sum instruction, e.g., Sum+=loadedVal, which may be based on a result, e.g., loadedVal, of the masked load operation.

As shown in Example 5a, the loop may include a select instruction, e.g., Sum=Select mask, Sum, PrevSum, to select between a first value, e.g., a value of the vector variable Sum, and a second value, e.g., a vector of a vector variable PrevSum, for example, based on the mask in the masked load operation.

As shown in Example 5a, the first value, e.g., the value of the vector variable sum, may be based on the result loadedVal of the masked load operation.

As shown in Example 5a, the second value in the vector variable PrevSum may be invariant in the loop.

In some demonstrative aspects, complier 160 may be configured to compile the loop, for example, based on the masked-select compilation mechanism, e.g., as described below.

In some demonstrative aspects, complier 160 may be configured to exclude the identified select operation from the loop, for example, by reconfiguring the masked load operation, e.g., as described below.

In some demonstrative aspects, complier 160 may reconfigure the masked load operation, for example, by setting the passthrough value of the reconfigured masked load operation to be equal to Zero, e.g., as follows:

```
Int4 Sum = {0,0,0,0}; Int4 PrevSum;
for (i = 0; i < Align_Up(n,4); i++) {
  Bool4 mask = (i < n); // will not need to be computed in the loop, used
  only by the load
  Int4 loadedVal = masked.load ptr, mask, passthrough=Zero //
    computing mask as part of the load is cheap: configured in advance
  Sum += loadedVal; // may have added to Sum zero values
} // no Select.
```

### Example (5b)

In some demonstrative aspects, as shown by Example 5b, the loop may include a reconfigured masked load operation, e.g., Int4 loadedVal=masked.load ptr, mask, passthrough=zero, including the passthrough equal to Zero.

In some demonstrative aspects, as shown by Example 5b, the passthrough value of the reconfigured masked load operation may be set to a value, e.g., Zero, which may support performing the sum instruction, e.g., while excluding the select instruction.

For example, the computation of the sum instruction may preserve the value passthrough=Zero set by the reconfigured masked load operation according to the mask.

In some demonstrative aspects, as shown by Example 5b, the select instruction may become redundant, and may be entirely excluded from the loop, for example, as a result of the setting of the passthrough value to Zero.

In some demonstrative aspects, as shown by Examples 4b and 5b, the masked-select compilation mechanism may be configured to implement a transformation, which may be configured to provide a technical solution to avoid redundant select instructions, e.g., as described below.

In some demonstrative aspects, as shown by Examples 4b and 5b, the masked-select compilation mechanism may be configured to provide a technical solution to leverage the passthrough of the masked memory operations, for example, to replace or exclude select operations.

In one example, an expression, denoted EXP, may be fed entirely by one or more masked loads. According to this example, default values may be injected to the expression EXP, for example, by injecting default values as a passthrough to the feeding masked loads. This implementation may provide a technical solution, which may support using the expression EXP, e.g., directly, for example, while avoiding a need to “filter out” values, e.g., via a select operation.

In some demonstrative aspects, as shown by Examples 4b and 5b, moving the masks from the select instruction into the reconfigured masked load operation may provide a technical solution to make the select instruction redundant.

In some demonstrative aspects, as shown by Examples 4b and 5b, moving the masks from the select instruction into the reconfigured masked load operation may provide a technical solution to avoid a need to compute the mask altogether, for example, on target architectures, which may have an ability to effectively drop masks from loads/stores, for example, when they are upper/lower bound masks.

For example, these bounds may be configured in advance, for example, into a unit that controls a memory accesses, e.g., an AGU. In one example, the upper/lower bound masks may be configured by setting the AGU Min/Max parameters.

In one example, compiler 160 may compile a source code 112 of another program to be executed by a target processor, e.g., processor 180.

For example, complier 160 may identify a loop including a select instruction based on source code 112, e.g., as follows:

```
for (I =0; I < Align_Up(n,32); i++) {
  Bool4 mask = (I < n);
  Int4 loadedVal = masked.load ptr, mask, passthrough=undef
  Int4 val = add (loadedVal, [2,2,2,2])
  Int4 filteredVal = Select mask, val, DefaultVal: Zero
  Use(filteredVal);
}
```

### Example (6a)

As shown in Example 6a, the loop may include a masked load operation, e.g., Int4 loadedVal=masked.load ptr, mask, passthrough=undef, including a mask and an undefined passthrough value, e.g., passthrough=undef.

As shown in Example 6a, the loop may include determining values of a vector variable, e.g., val, for example based on an add instruction, e.g., Int4 val=add (loadedVal, [2,2,2,2]), which may be based on a sum of a result, e.g., loadedVal, of the masked load operation, and a predefined vector, e.g., the vector [2,2,2,2], e.g., representing an operation of “an addition of two”.

As shown in Example 6a, the loop may include a select instruction, e.g., Int4 filteredVal=Select mask, val, DefaultVal: Zero, to select between a first value, e.g., a value of the vector variable Val, and a second value, e.g., DefaultVal: Zero, for example, based on the mask in the masked load operation.

As shown in Example 6a, the first value val may be based on the result loadedVal of the masked load operation.

In some demonstrative aspects, complier 160 may be configured to compile the loop, for example, based on the masked-select compilation mechanism, e.g., as described below.

In some demonstrative aspects, complier 160 may be configured to exclude the identified select operation from the loop, for example, by reconfiguring the masked load operation, e.g., as described below.

As shown in Example. 6a, the passthrough result of the masked load operation may be affected by one or more operations in the loop.

In some demonstrative aspects, the second value, e.g., DefaultVal: Zero, which is applied by the select operation, may not be affected by the addition of two in the add instruction.

In some demonstrative aspects, the passthrough value of the reconfigured mask load operation may be configured, for example, to compensate for the addition of two, for example, in case the select operation is to be excluded, e.g., as described below.

In some demonstrative aspects, complier 160 may reconfigure the masked load operation, for example, based on the add instruction val=add (loadedVal, [2,2,2,2]), which may affect the passthrough value.

some demonstrative aspects, complier 160 may reconfigure the masked load operation, for example, such that the passthrough value of the reconfigured mask load operation may result in the second value in the select operation, e.g., the default value DefaultVal: Zero.

In some demonstrative aspects, complier 160 may reconfigure the masked load operation, for example, by setting the passthrough value of the reconfigured mask load operation to be equal to (−2), for example, to compensate for the addition of two by the add instruction, e.g., as follows:

```
for (I =0; I < Align_Up(n,32); i++) {
  Bool4 mask = (I < n);
  Int4 loadedVal = masked.load ptr, mask, passthrough=−2 //
    passthrough is different than the Default value (zero) because of the
    compute on the way
  Int4 val = add (loadedVal, [2,2,2,2])
  Use(filteredVal);
}
```

### Example (6b)

In some demonstrative aspects, as shown by Example 6b, the loop may include a reconfigured masked load operation, e.g., Int4 loadedVal=masked.load ptr, mask, passthrough=−2, including the passthrough equal to (−2).

In some demonstrative aspects, as shown by Example 6b, the passthrough of the reconfigured mask load operation may be set to a value, e.g., (−2), for example, to support performing the add instruction, e.g., while excluding the select instruction.

For example, the computation of the add instruction may add the value 2 to the value passthrough=−2 set by the masked load operation according to the mask.

Accordingly, setting the passthrough of the reconfigured mask load operation to the value (−2) may provide a technical solution to preserve the zero default value of the select instruction.

In some demonstrative aspects, as shown by Example 6b, the select instruction may become redundant, and may be entirely excluded from the loop, as a result of setting the passthrough value of the reconfigured mask load operation to (−2).

In some demonstrative aspects, as shown by Examples 4b, 5b, and 6b, the masked-select compilation mechanism may be configured to provide a technical solution to support setting for a masked operation a suitable passthrough value, which may result in preserving the original Default-value (DefaultVal) of the select instruction.

For example, a passthrough value of a masked-load instruction may be configured to provide a desired Default-value (DefaultVal) of the select instruction, for example, when the passthrough value is propagated through computations on the way to the select instruction.

In one example, as shown by examples 4b and 5b, the passthrough value in the reconfigured masked-load instruction may include the Default value==Zero, which may be preserved through computations, e.g., multiplication and/or sum instructions, on the way to the select instruction.

In another example, as shown by example 6b, the passthrough value in the reconfigured masked-load instruction may include the Default value==−2, such that the Default value==Zero may be preserved through computations, e.g., the add instruction, on the way to the select instruction.

In one example, compiler 160 may compile a source code 112 of another program to be executed by a target processor, e.g., processor 180.

For example, complier 160 may identify a scalar code based on source code 112, e.g., as follows:

```
for (I = 0; I < 1024; i++) {
  int loadedVal = a[i] // = = load from &a[i]
  int SomeVal = 0;
  if (I < Bound)
    SomeVal = loadedVal * 2;
  a[i] = SomeVal;
}
```

### Example (7a)

In some demonstrative aspects, compiler 160 may be configured to facilitate vectorization, for example, by converting “if” expressions into “select” expressions, for example, according to an if-conversion mechanism.

In some demonstrative aspects, compiler 160 may be configured to generate target code 115, for example, based on code generated based on the if-conversion mechanism, e.g., as follows:

```
for (I = 0; I < 1024; i++) {
  int loadedVal = a[i] // == load from &a[i]
  int SomeVal = ((I < Bound) ? loadedVal * 2 : 0; ) // Select
  a[i] = SomeVal;
}
```

### Example (7b)

As shown in Example (7b), the compilation process may result in code including select operations.

In some demonstrative aspects, compiler 160 may be configured to compile one or more of these select instructions, for example, based on the masked-select compilation mechanism, e.g., as described above.

In some demonstrative aspects, compiler 160 may be configured to configure a masked operation to replace an identified select instruction, e.g., as described above.

In some demonstrative aspects, compiler 160 may be configured to replace an identified select instruction with a reconfigured select instruction, e.g., as described below.

In some demonstrative aspects, the reconfigured select instruction may include a select according to a simplified mask, which may be, for example, simplified relative to the mask of the identified select instruction, e.g., as described below.

In some demonstrative aspects, in some use cases and/or scenarios, it may not be efficient and/or possible to entirely remove/exclude an identified select instruction.

In some demonstrative aspects, in some use cases and/or scenarios, it may be possible to simplify a mask of the identified select instruction, e.g., as described below.

For example, a masked-select operation may be used, e.g., as follows:

SomeVal = load or masked_load with LoadMask=M and
passthrough = Zero or Undef;
Mask2 = (SomeVal > Limit);
SelectMask = Mask1 AND Mask2;
Select SelectMask ? SomeVal : Zero

### Example (8a)

For example, it may not be efficient and/or possible to fold the entire SelectMask instruction into the load operation, for example, as the load operation may affect the value (feed) the SelectMask instruction.

For example, the SelectMask instruction may be partially folded into the load operation.

For example, a part of the mask of the SelectMask instruction, e.g., the Mask1 mask-part, may be folded into the load operation, e.g., as follows:

SomeVal = masked_load with LoadMask=M AND Mask1 with
passthrough = Zero;
Mask2 = (SomeVal > Limit);
Select Mask2 ? SomeVal : Zero

### Example (8b)

For example, according to Example 8b, the load operation may be configured based on the mask part Mask1.

For example, according to Example 8b, the SelectMask instruction may be reconfigured based on a simplified mask, e.g., using the mask part Mask2.

For example, this implementation of Example 8b may provide a technical solution, for example, in a situation where it is computationally expensive to compute the mask part Mask1 disjoint from the load operation.

For example, this solution may be implemented by targets that can efficiently compute the mask part Mask1 as part of the load operation.

In some demonstrative aspects, compiler 160 may be configured to compile code in a loop based on the source code 112, for example, according to a masked-select compilation mechanism, which may be configured to include one or more operations, e.g., as described below.

In some demonstrative aspects, the masked-select compilation mechanism may include an operation of gathering all candidate select instructions in the loop, e.g., as described below.

In some demonstrative aspects, the masked-select compilation mechanism may include identifying a select instruction of a predefined form, e.g., the following form:
Select SelectMask? SomeValue: DefaultValue

In some demonstrative aspects, this form of the select instruction may be configured to select between a first value, denoted SomeValue, and a second value, denoted DefaultValue, for example, based on a mask, denoted SelectMask.

In some demonstrative aspects, the masked-select compilation mechanism may include identifying one or more identified select instructions, e.g., by identifying a select instruction where the DefaultValue may be invariant to the loop, e.g., as described above.

In some demonstrative aspects, the masked-select compilation mechanism may include applying a mask-select compilation scheme to compile the one or more identified select instructions, e.g., as described below.

In some demonstrative aspects, the mask-select compilation scheme may be configured to configure a masked operation based on an identified select instruction, e.g., as described below.

In some demonstrative aspects, the masked-select compilation mechanism may include determining the mask-select compilation scheme to be applied for compiling the identified select instruction, for example, based on a criterion relating to a variation of the result of the masked operation through the loop, e.g., as described below.

In some demonstrative aspects, the criterion may be based on a determination whether the DefaultValue of the identified select instruction is preserved through the loop between the masked operation and the select instruction, e.g., as described below.

In some demonstrative aspects, the masked-select compilation mechanism may include applying a first masked-select compilation scheme to an identified select instruction, for example, based on a determination that the defaultValue of the identified select instruction may be preserved by the operations on the way from load instructions to the value SomeValue in the identified select instruction in the loop, e.g., as described below.

In some demonstrative aspects, the first masked-select compilation scheme may include one or more operations to configure the masked operation based on the identified select instruction, e.g., as follows:

Algorithm (1)

| 1. | Stage1: Collect all the loads that feed SomeValue: | |
|---|---|---|
| | Loads = { } | |
| | Inst = SomeValue; | |
| | collect_loads(Inst, DefaultVal, Loads){ | |
| | if (Inst is an Instruction outside Loop) | |
| | | return; |
| | if (Inst is not a load, and is an Instruction that Preserves DefaultVal?) { // e.g. | |
| | cast, extract, shuffle | |
| | | // continue up the def-use chain to Instructions that feed Inst, to see if |
| | | we eventually reach a load. |
| | | foreach_argument_of_Inst(arg) |
| | | collect_loads(arg, DefaultVal, Loads); |
| | | return; |
| | } | |
| | if (Inst is a load) | |
| | | Insert Inst into Loads; |
| | | Return; |
| | } | |
| 2. | Stage2: Legality checks: | |
| | a. | If any of the loads in Loads feed the computation of SelectMask - fail. |
| | b. | If we need to change the Mask of a load in Loads, and that load feeds |
| | Instructions that are not “consumed” by SelectInst (e.g., the load feeds | |
| | instructions other than SelectInst and SelectInst doesn't post dominate them) - | |
| | then fail. | |
| | c. | If for any of the loads in Loads the DefaultValue cannot be set as |
| | passthrough (e.g. data-type doesn't match) - fail | |
| 3. | Stage3: Apply the transformation: | |
| | a. | For each of the loads in Loads : { |
| | | If the load is unmasked: |
| | | transform it into a masked load and set its mask to SelectMask. |
| | | Else // this is a masked-load with mask m: |
| | | Set the load mask to (m AND SelectMask); // if needed; SelectMask |
| | | may be already included in m. |
| | | } |
| | | Set the passthrough of the load to DefaultValue |
| | b. | Remove the select and set all the uses of the SelectInst to use SomeValue |
| | | directly (instead of via the selection, which is not redundant). |

In some demonstrative aspects, one or more operations of the first masked-select compilation scheme according to the Algorithm 1 may be extended and/or optimized, for example, to address one or more use cases and/or implementations, e.g., as described below.

In some demonstrative aspects, the first masked-select compilation scheme may be applied, for example, in case a SelectMask operation is formed as a logical AND of several mask-parts.

For example, one or more operations of the Algorithm 1 may be applied, for example, for each mask part separately. For example, this implementation may be configured to provide a technical solution to support a pass of the legality-checks of Stage2 of Algorithm 1, and/or make the Algorithm 1 applicable to one or more use cases.

In some demonstrative aspects, an operation to collect memory operations, e.g., the condition “Inst is an Instruction that Preserves DefaultVal?” in Stage1 of Algorithm 1, may be extended for one or more cases, e.g., special, cases.

For example, a case where DefaultVal=zero may return a positive result for some types of instructions, such as multiplication, subtraction, addition, shift, And, Or, Xor, or the like.

In some demonstrative aspects, Stage1 of the Algorithm 1 may be extended, for example, to support cases, in which the DefaultValue is changed along the way in the loop, for example, to adapt to the instructions encountered along the way, e.g., as described below.

In some demonstrative aspects, the masked-select compilation mechanism may include applying a second masked-select compilation scheme to an identified select instruction, for example, based on a determination that the defaultValue of the identified select instruction may not be preserved, for example, by the operations on the way between a load instruction and the value SomeValue in the identified select instruction in the loop, e.g., as described below.

In some demonstrative aspects, the second masked-select compilation scheme may include one or more operations to configure the masked operation based on the identified select instruction, e.g., as follows:

Algorithm (2)

| | |
|---|---|
| | Helper function: NewDefaultVal = getNewDefaultVal (Inst, DefaultVal): |
| | Let arg be the constant argument of Inst. The constant value is C // e.g. |
| | Inst= add(Someval, 2) |
| | Switch (Operations){ |
| | Case Add: return DefaultVal − C; |
| | Case Sub: return DefaultVal + C; |
| | Case Mul: if DefaultVal divides by C: return DefaultVal / C |
| | Case ShiftRight: DefaultVal << C // if C is small enough |
| | Case ShiftLeft: DefaultVal >> C // if C is small enough |
| | Etc. |
| | } |
| | } |
| | Main function per SelectInst: |
| | Given a SelectInst in Loop, that selects between SomeValue and a |
| | DefaultValue that is invariant in Loop based on a SelectMask: |
| 1. | Stage1: Collect all the loads that feed SomeValue: |
| | Loads_and_DefaultVals = { } // holds pairs of {load, DefaultVal} |
| | Inst = SomeValue; |
| | collect_loads(Inst, DefaultVal, Loads){ |
| | if (Inst is an Instruction outside Loop) |
| | return; |
| | if (Inst is not a Load) { |
| | if (arg1 of Inst is the Constant C) // for simplicity referring only single |
| | constant argument, trivially extended to more |
| | NewDefaultVal = getNewDefaultVal (Inst, DefaultVal); |
| | foreach_all_other_arguments_of_Inst(arg) |
| | collect_loads(arg, NewDefaultVal, Loads_and_DeaultVals); |
| | } else // all arguments are non-constant |
| | // continue up the def-use chain to Instructions that feed Inst, to see if we |
| | eventually reach a load. |
| | foreach_argument_of_Inst(arg) |
| | collect_loads(arg, DefaultVal, Loads); |
| | } |
| | } |
| | if (Inst is a load) |
| | Insert Inst into Loads_and_DefaultVals( pair{load, DefaultVal)); |
| | Return; |
| | } |
| 2. | Stage2: Legality checks: |
| a. | Convert SelectMask into a form: SelectMask = MASK1 AND MASK2 AND |
| | MASK3... |
| | Set NewMask = true; |
| | for each mask-part M from MaskParts={MASK1,MASK2,MASK3...} { |
| | If any of the loads in Loads feed the computation of SelectMask - continue |
| | (This mask-part will not be simplified); |
| | Else: { remove M from MaskParts; Set NewMask &= M; } |
| | } |
| b. | If we need to change the Mask of a load in Loads, and that load feeds |
| | Instructions that are not “consumed” by SelectInst (namely, the load feeds |
| | instructions other than SelectInst and SelectInst doesn't post dominate them) - |
| | then fail. |
| c. | If for any of the loads in Loads the DefaultValue cannot be set as passthrough |
| | (e.g. data-type doesn't match) - fail |
| 3. | Stage3: Apply the transformation: |
| a. | For each of the pairs {load, DefaultVal} in Loads_and_DefaultVals : { |
| | If the load is unmasked: |
| | transform it into a masked load and set its mask to NewMask. |
| | Else // this is a masked-load with mask m: |
| | Set the load mask to (m AND NewMask); // if needed; NewMask may be |
| | already included in m. |
| | } |
| | Set the passthrough of the load to DefaultVal. |
| b. | If (MaskParts is empty) // all the mask parts can be fed into loads |

Remove the select and set all the uses of the SelectInst to use SomeValue directly
(instead of via the selection, which is not redundant).

```
  else {
    // can't remove the Select; But can simplify the select Mask
    SimplifiedSelectMask = AND of all the mask parts that remained in
```

MaskParts.

Set the mask of the SelectInst to SImplifiedSelectMask

}

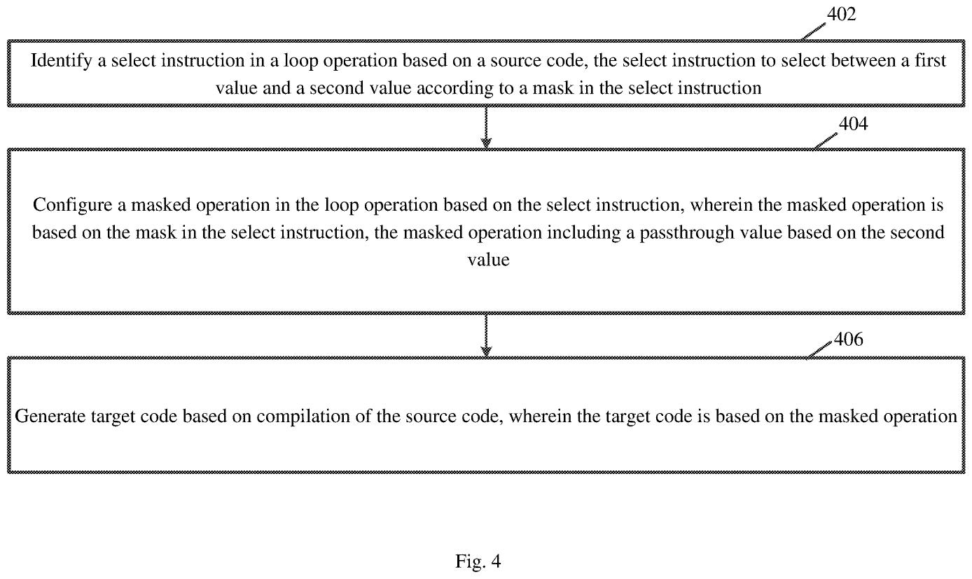

Reference is made to FIG. 4, which schematically illustrates a method of compiling code for a processor. For example, one or more operations of the method of FIG. 4 may be performed by a system, e.g., system 100 (FIG. 1); a device, e.g., device 102 (FIG. 1); a server, e.g., server 170 (FIG. 1); and/or a compiler, e.g., compiler 160 (FIG. 1), and/or compiler 200 (FIG. 2).

In some demonstrative aspects, as indicated at block 402, the method may include identifying a select instruction in a loop operation based on a source code. For example, the select instruction may be configured to select between a first value and a second value according to a mask in the select instruction. For example, compiler 160 (FIG. 1) may be configured to identify the select instruction in the loop operation, for example, based on the source code 112 (FIG. 1), e.g., as descried above.

In some demonstrative aspects, as indicated at block 404, the method may include configuring a masked operation in the loop operation based, for example, on the select instruction. For example, the masked operation may be based on the mask in the select instruction. For example, the masked operation may include a passthrough value, which may be based, for example, on the second value. For example, compiler 160 (FIG. 1) may be configured to configure the masked operation in the loop operation based, for example, on the identified select instruction, e.g., as descried above.

In some demonstrative aspects, as indicated at block 406, the method may include generating target code based on compilation of the source code. For example, the target code may be based on the masked operation. For example, compiler 160 (FIG. 1) may be configured to generate target code 115 (FIG. 1), for example, based on the masked operation, e.g., as descried above.

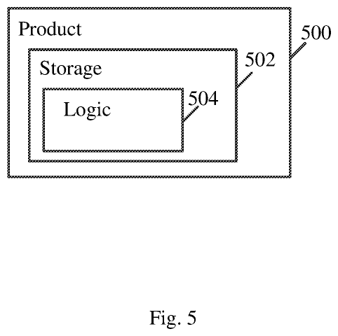

Reference is made to FIG. 5, which schematically illustrates a product of manufacture 500, in accordance with some demonstrative aspects. Product 500 may include one or more tangible computer-readable (“machine-readable”) non-transitory storage media 502, which may include computer-executable instructions, e.g., implemented by logic 504, operable to, when executed by at least one computer processor, enable the at least one computer processor to implement one or more operations at device 102 (FIG. 1), server 170 (FIG. 1), and/or compiler 160 (FIG. 1), to cause device 102 (FIG. 1), server 170 (FIG. 1), and/or compiler 160 (FIG. 1) to perform, trigger and/or implement one or more operations and/or functionalities, and/or to perform, trigger and/or implement one or more operations and/or functionalities described with reference to the FIGS. 1-4, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 500 and/or machine-readable storage media 502 may include one or more types of computer-readable storage media capable of storing data, including volatile memory, non-volatile memory, removable or non-removable memory, erasable or non-erasable memory, writeable or re-writeable memory, and the like. For example, machine-readable storage media 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes a product comprising one or more tangible computer-readable non-transitory storage media comprising computer-executable instructions operable to, when executed by at least one processor, enable the at least one processor to cause a compiler to identify a select instruction in a loop operation based on a source code, the select instruction to select between a first value and a second value according to a mask in the select instruction; configure a masked operation in the loop operation based on the select instruction, wherein the masked operation is based on the mask in the select instruction, the masked operation comprising a passthrough value based on the second value; and generate target code based on compilation of the source code, wherein the target code is based on the masked operation.

Example 2 includes the subject matter of Example 1, and optionally, wherein the first value is based on the mask in the select instruction.

Example 3 includes the subject matter of Example 1 or 2, and optionally, wherein the instructions, when executed, cause the compiler to configure the masked operation by reconfiguring an other masked operation in the loop.

Example 4 includes the subject matter of Example 3, and optionally, wherein the instructions, when executed, cause the compiler to configure the masked operation by reconfiguring a passthrough value of the other masked operation based on the second value.

Example 5 includes the subject matter of Example 3 or 4, and optionally, wherein the instructions, when executed, cause the compiler to configure the masked operation by reconfiguring a passthrough value of the other masked operation based on one or more operations to be applied to a result of the other masked operation in the loop.

Example 6 includes the subject matter of any one of Examples 3-5, and optionally, wherein the other masked operation comprises an undefined passthrough value.

Example 7 includes the subject matter of any one of Examples 3-5, and optionally, wherein the other masked operation comprises a default value of the select instruction.

Example 8 includes the subject matter of any one of Examples 3-7, and optionally, wherein the first value is based on a result of the other masked operation.

Example 9 includes the subject matter of any one of Examples 1-8, and optionally, wherein the instructions, when executed, cause the compiler to identify the select instruction according to a criterion relating to a variation of a result of the masked operation through the loop.

Example 10 includes the subject matter of any one of Examples 1-9, and optionally, wherein the instructions, when executed, cause the compiler to identify the select instruction based on a determination that the second value is invariant in the loop.

Example 11 includes the subject matter of any one of Examples 1-10, and optionally, wherein the instructions, when executed, cause the compiler to set the passthrough value based on a variation of a result of the masked operation through the loop.

Example 12 includes the subject matter of any one of Examples 1-11, and optionally, wherein the instructions, when executed, cause the compiler to set the passthrough value based on one or more operations to be applied to a result of the masked operation in the loop.

Example 13 includes the subject matter of Example 12, and optionally, wherein the instructions, when executed, cause the compiler to set the passthrough value such that the one or more operations, when applied to the result of the masked operation, result in the second value in the identified select instruction.

Example 14 includes the subject matter of any one of Examples 1-13, and optionally, wherein the instructions, when executed, cause the compiler to identify one or more operations in the loop operation, which affect a result of the masked operation, and to configure the passthrough value based on the one or more operations.

Example 15 includes the subject matter of any one of Examples 1-10, and optionally, wherein the instructions, when executed, cause the compiler to set the passthrough value to be equal to the second value.

Example 16 includes the subject matter of any one of Examples 1-10, and optionally, wherein the instructions, when executed, cause the compiler to set the passthrough value to be equal to the second value based on a determination that the second value is invariant in the loop.

Example 17 includes the subject matter of any one of Examples 1-16, and optionally, wherein the masked operation is configured to replace the select instruction.

Example 18 includes the subject matter of any one of Examples 1-17, and optionally, wherein the instructions, when executed, cause the compiler to exclude the select instruction from the loop operation.

Example 19 includes the subject matter of any one of Examples 1-16, and optionally, wherein the mask in the select instruction comprises a first mask, wherein the instructions, when executed, cause the compiler to reconfigure the identified select instruction according to a second mask, which is different from the first mask.

Example 20 includes the subject matter of any one of Examples 1-16, and optionally, wherein the instructions, when executed, cause the compiler to reconfigure the identified select instruction according to a simplified mask, which is simplified relative to the mask in the identified select instruction.

Example 21 includes the subject matter of any one of Examples 1-20, and optionally, wherein the masked operation comprises a masked memory-access operation.

Example 22 includes the subject matter of any one of Examples 1-21, and optionally, wherein the masked operation comprises a masked load operation to conditionally load values from a memory according to the mask.

Example 23 includes the subject matter of any one of Examples 1-22, and optionally, wherein the mask comprises a mask vector, wherein the first value comprises a value of a vector variable having a same size as the mask vector.

Example 24 includes the subject matter of any one of Examples 1-23, and optionally, wherein the source code comprises Open Computing Language (OpenCL) code.

Example 25 includes the subject matter of any one of Examples 1-24, and optionally, wherein the computer-executable instructions, when executed, cause the compiler to compile the source code into the target code according to a Low Level Virtual Machine (LLVM) based (LLVM-based) compilation scheme.

Example 26 includes the subject matter of any one of Examples 1-25, and optionally, wherein the target code is configured for execution by a Very Long Instruction Word (VLIW) Single Instruction/Multiple Data (SIMD) target processor.

Example 27 includes the subject matter of any one of Examples 1-26, and optionally, wherein the target code is configured for execution by a target vector processor.

Example 28 includes a compiler configured to perform any of the described operations of any of Examples 1-27.

Example 29 includes a computing device configured to perform any of the described operations of any of Examples 1-27.

Example 30 includes a computing system comprising at least one memory to store instructions; and at least one processor to retrieve instructions from the memory and execute the instructions to cause the computing system to perform any of the described operations of any of Examples 1-27.

Example 31 includes a computing system comprising a compiler to generate target code according to any of the described operations of any of Examples 1-27, and a processor to execute the target code.

Example 32 comprises an apparatus comprising means for executing any of the described operations of any of Examples 1-27.

Example 33 comprises an apparatus comprising: a memory interface; and processing circuitry configured to: perform any of the described operations of any of Examples 1-27.

Example 34 comprises a method comprising any of the described operations of any of Examples 1-27.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-32. (canceled)

33. A product comprising one or more tangible computer-readable non-transitory storage media comprising computer-executable instructions operable to, when executed by at least one processor, enable the at least one processor to cause a compiler to:
identify a select instruction in a loop operation based on a source code, the select instruction to select between a first value and a second value according to a mask in the select instruction;
configure a masked operation in the loop operation based on the select instruction, wherein the masked operation is based on the mask in the select instruction, the masked operation comprising a passthrough value based on the second value; and
generate target code based on compilation of the source code, wherein the target code is based on the masked operation.

34. The product of claim 33, wherein the first value is based on the mask in the select instruction.

35. The product of claim 33, wherein the instructions, when executed, cause the compiler to configure the masked operation by reconfiguring an other masked operation in the loop operation.

36. The product of claim 35, wherein the instructions, when executed, cause the compiler to configure the masked operation by reconfiguring a passthrough value of the other masked operation based on the second value.

37. The product of claim 35, wherein the instructions, when executed, cause the compiler to configure the masked operation by reconfiguring a passthrough value of the other masked operation based on one or more operations to be applied to a result of the other masked operation in the loop operation.

38. The product of claim 35, wherein the other masked operation comprises an undefined passthrough value.

39. The product of claim 35, wherein the other masked operation comprises a default value of the select instruction.

40. The product of claim 35, wherein the first value is based on a result of the other masked operation.

41. The product of claim 33, wherein the instructions, when executed, cause the compiler to identify the select instruction according to a criterion relating to a variation of a result of the masked operation through the loop operation.

42. The product of claim 33, wherein the instructions, when executed, cause the compiler to identify the select instruction based on a determination that the second value is invariant in the loop operation.

43. The product of claim 33, wherein the instructions, when executed, cause the compiler to set the passthrough value based on a variation of a result of the masked operation through the loop operation.

44. The product of claim 33, wherein the instructions, when executed, cause the compiler to set the passthrough value based on one or more operations to be applied to a result of the masked operation in the loop operation.

45. The product of claim 33, wherein the instructions, when executed, cause the compiler to identify one or more operations in the loop operation, which affect a result of the masked operation, and to configure the passthrough value based on the one or more operations.

46. The product of claim 33, wherein the instructions, when executed, cause the compiler to set the passthrough value to be equal to the second value.

47. The product of claim 33, wherein the masked operation is configured to replace the select instruction.

48. The product of claim 33, wherein the instructions, when executed, cause the compiler to exclude the select instruction from the loop operation.

49. The product of claim 33, wherein the mask in the select instruction comprises a first mask, wherein the instructions, when executed, cause the compiler to reconfigure the identified select instruction according to a second mask, which is different from the first mask.

50. The product of claim 33, wherein the instructions, when executed, cause the compiler to reconfigure the identified select instruction according to a simplified mask, which is simplified relative to the mask in the identified select instruction.

51. The product of claim 33, wherein the masked operation comprises a masked memory-access operation.

52. The product of claim 33, wherein the masked operation comprises a masked load operation to conditionally load values from a memory according to the mask.

53. The product of claim 33, wherein the mask comprises a mask vector, wherein the first value comprises a value of a vector variable having a same size as the mask vector.

54. A computing system comprising:
at least one memory to store instructions; and
at least one processor to retrieve the instructions from the memory and to execute the instructions to cause the computing system to:
identify a select instruction in a loop operation based on a source code, the select instruction to select between a first value and a second value according to a mask in the select instruction;
configure a masked operation in the loop operation based on the select instruction, wherein the masked operation is based on the mask in the select instruction, the masked operation comprising a passthrough value based on the second value; and
generate target code based on compilation of the source code, wherein the target code is based on the masked operation.

55. The computing system of claim 54 comprising a target processor to execute the target code.

56. A method comprising:
identifying a select instruction in a loop operation based on a source code, the select instruction to select between a first value and a second value according to a mask in the select instruction;
configuring a masked operation in the loop operation based on the select instruction, wherein the masked operation is based on the mask in the select instruction, the masked operation comprising a passthrough value based on the second value; and
generating target code based on compilation of the source code, wherein the target code is based on the masked operation.

57. The method of claim 56 comprising identifying the select instruction according to a criterion relating to a variation of a result of the masked operation through the loop operation.
